(19) United States
(12) Patent Application Publication
(10) Pub. No.: US 2012/0209625 A1
(43) Pub. Date: Aug. 16, 2012

(54) ARTIFICIAL INTELLIGENCE-ASSISTED MEDICAL REFERENCE SYSTEM AND METHOD

(75) Inventors: John M. Armstrong, Junction City, KS (US); Ramona R. Leibnitz, Junction City, KS (US); Vladimir Dobrynin, St. Petersburg (RU); David Patterson, Jordanstown (GB)

(73) Assignee: Lead Horse Technologies, Inc.

(21) Appl. No.: 13/265,830

(22) PCT Filed: Apr. 21, 2010
(86) PCT No.: PCT/US10/31931

§ 371 Date: May 4, 2012

Related U.S. Application Data
(60) Provisional application No. 61/171,796, filed on Apr. 22, 2009.

(51) Int. Cl. G06Q 50/22; G06Q 50/24

(52) U.S. Cl. 705/3; 705/2

(57) ABSTRACT

Computer-implemented methods, systems, and computer-readable storage mediums are provided for use with a clinical decision support system for identifying and providing information regarding associations between patient attributes and one or more Adverse Events (AEs). In one example, a process includes processing database information comprising AEs and one or more patient attributes for associations between AEs and patient attributes and identifying at least one association between one or more AEs and one or more patient attributes. The association(s) may be discovered through an association rule discovery process to determine one or more association rules, where each association rule satisfies a confidence, support, and/or other threshold. The exemplary process further provides information or alerts to a user based on the identified or discovered association(s). The information may further be used to weight and reprioritize search results for AEs based on drug (prescription or otherwise) safety or efficacy information.

### CROSS REFERENCE TO RELATED APPLICATION

This application claims benefit to provisional application U.S. Ser. No. 61/171,796, filed Apr. 22, 2009, which is hereby incorporated by reference in its entirety for all purposes.

### FIELD OF THE INVENTION

The present invention relates generally to a computer-based, clinical decision support system for processing adverse events (e.g., pre- and post-marketing adverse drug events, reported adverse events, etc.) and patient attributes (e.g., medications, conditions, symptoms, medical devices or procedures, demographic data, etc.) to provide alerts to users about potentially significant associations (causal or not) and/or to prioritize results retrieved from pharmaceutical drug labels in response to a user's query.

### BACKGROUND OF THE INVENTION

It is often the case that after a drug is approved by a nation's regulatory agency for the treatment of a given disease or disorder, the safety information known to be associated with that drug comes from a benefit/risk analysis of the results from a clinical trial that enrolled a relatively small patient population narrowly defined in terms of allowable complicating factors. The safety information is typically included with the drug for use and reference by users. Further, some regulatory agencies (such as the U.S. Food and Drug Administration (FDA)), maintain a database cataloging safety information for various drugs in a process known as post-marketing safety surveillance, or pharmacovigilance (e.g., the FDA maintains an Adverse Event Reporting System (AERS) database of safety information).

After a drug is approved and used outside of a clinical trial setting, the drug is often used by patients who are much more complicated in terms of the number and types of other medications they are taking and the background conditions and symptoms they already have, compared to the patients who were in the clinical trial. After a drug is approved for use and additional safety events, such as adverse events (AEs) or adverse drug reactions (ADRs), are discovered through post-marketing safety surveillance, regulatory agencies require drug manufacturers to reflect that new information by adding cautions and other warnings to the drug label. However, although some drug-drug interaction information may be published in a drug's label, an entirely new set of serious adverse events associated with any specific drug may be recognized when: 1) another, additional drug becomes approved and the two drugs become associated with an AE or ADR that is not reflected in the drug label for either; or 2) the drug is used in patients with background conditions and symptoms or other patient attributes that were not allowed (i.e., were not in the inclusion criteria or were listed in the exclusion criteria) in the original “registration” clinical trial upon which regulatory agency approval was based, or if they were, were not included in high enough numbers (i.e., the trial was not “powered” adequately) to allow detection of significant associations of AEs or ADRs with that drug in patients with those specific background conditions and symptoms or other patient attributes. As a consequence, sole reliance on the relatedness of a drug with an AE or ADR as stated in drug labels may be inadequate to explain AE or ADR experiences observed in the clinic after a drug has been approved by a regulatory agency for use in the market. In fact, the U.S. National Academy of Science's Institute of Medicine has observed that there continue to be more than 1.5 million ADRs reported in the U.S. each year, in spite of the availability of point-of-care drug-drug interaction detection products based on access to published drug label data. Moreover, even before a drug label has been published, i.e., before a drug has been approved for use in the market by a regulatory agency, or after it has been approved for use in the market but before it has been approved for a new disease or condition or in a new patient demographic group, that drug is allowed by regulatory agencies to be prescribed by healthcare professionals in a process that is known as “off-label” use. As such, there are often situations in which a drug is prescribed when no drug label exists or no safety or efficacy information has been published in an existing drug label with respect to the kind of patient for whom that drug is being prescribed. Any subsequent AEs or ADRs associated with the off-label use of that drug may or may not be reported to the regulatory agency. Consequently, important decision support information about AEs or ADRs experienced by some healthcare professionals may not be available to other healthcare professionals also prescribing that drug in an off-label manner.

Drug label information is published by pharmaceutical companies that manufacture drugs. A point-of-care medical reference system or decision support system (DSS) can be used to enable users to search through drug labels to find AEs or ADRs that a particular prescribed drug may cause or with which it may be otherwise associated. This feature enables the medical practitioner to make more informed decisions as to which drug or drugs may be contributing to an observed AE or AEs. However, regulatory agencies such as the FDA do not require drug manufacturers to update their drug labels until specific thresholds regarding specific safety events have been reached, based on the FDA's post-marketing safety surveillance as reported to their AERS database or from supplemental clinical trial information as is derived from typical Phase IV trials. As a result, many of the more serious ADRs (those that typically result in hospitalization or death) that are not detectable until a drug has been prescribed in many thousands, or hundreds of thousands, of patients are not discovered and published in a drug's label until several years have passed since the date when a drug was first approved for use in the market. Moreover, significant delays can occur from the time an association between a drug or drugs and an AE has been validated and required by the FDA to be published in a drug's label by a drug manufacturer before the updated drug label is published and made available to healthcare professionals. In the interim, to reduce the frequency of, or prevent, ADRs healthcare professionals must rely on additional sources of drug safety information other than drug labels to support their medical treatment or prevention decisions. However, even though serious safety events associated with a specific drug, drug combination, or drug-patient attribute combination may have been reported to a regulatory agency, information about those reports may not be accessible to healthcare professionals, leaving the healthcare professional unaware of that information related to significant drug-AE associations that have been discovered through pharmacovigilance efforts but which have not yet been published and/or made available to the healthcare professional.

In addition, in the course of processing an ADR query through a DSS, the use of a pre-specified ranking or prioritization algorithm to determine the order of results retrieved from drug labels and presented to the doctor making the query either ignores the relevance of information retrieved from drug labels to the type of patient being treated or presumes that the algorithm has a built-in awareness of that information. The degree to which ADR information contained in drug labels reflects the reality of the seriousness and frequency of that ADR in the post-marketing world (i.e., the safety experience of that drug outside of the relatively small and demographically defined patient population that was used in the clinical trial upon which the drug's approval was based) depends on many factors, including how often drug labels are updated to reflect changes in those factors in the post-marketing world.

### SUMMARY OF THE INVENTION

According to one aspect of the present invention, computer-implemented methods, systems, and computer-readable storage mediums are provided for use with a clinical decision support system for identifying and providing information regarding associations between patient attributes and one or more AEs, which may be used for providing alerts or displaying potential AEs.

In one example, a process for providing information (e.g., alerts) regarding associations between patient attributes and one or more AEs includes processing database information comprising AEs and one or more patient attributes for associations between AEs and patient attributes. The database of AEs and patient attributes may include AERS data, ADRs, user-generated reports comprising AEs, additional safety events associated with prescription or non-prescription drugs, herbal supplements, other substances or foods, medical devices, clinical procedures, other patient attributes, demographic data, and so on. The exemplary process further includes identifying at least one association between one or more AEs and one or more patient attributes. The association(s) may be discovered through an association rule discovery or other artificial intelligence (AI) technology processes to determine one or more association rules, where each association rule satisfies one or more thresholds for confidence, support, and/or other statistical parameters. The exemplary process further provides information to a user based on the identified or discovered association(s). The information may include alerts, reports, bulletins, or the like.

In one example, the identified associations may be used to process patient data records (e.g., associated with a hospital, organization, or user) to alert the user of patients who may be vulnerable to the association rule-based identification of potential risks or safety information. For example, an identified association may be used to identify a relationship between the use of two drugs and an AE, for which the user is alerted. In one example, a set of patient data, including prescribed drugs and AEs, may be analyzed based on identified associations.

In another example, the rule discovery process and discovered association(s) may be used to display information regarding ADRs published in a pharmaceutical drug label. For example, the system and process may use the rule discovery process for changing the prioritized ranking of pharmaceutical drug label-derived results of an ADR query that was made through a computer-based medical reference system. The drug label derived results that are normally returned according to some pre-specified prioritization algorithm are, as an option, re-ranked by allowing AI-based weighting factors to be applied. For example, an exemplary process includes accessing a computer readable storage memory storing records of drug safety or efficacy information, such as drug label segments, ordering at least a portion of the drug label segments based on input patient attributes (according to a ranking algorithm based on density of key terms, emphasized language, or the like), applying one or more association rules to the drug label segments, the association rules identified from a database of AEs and patient attributes, and reordering the drug label segments based on the association rules.

According to other embodiments, systems, apparatuses (e.g., computers, server computers, and the like), interfaces, and computer-readable storage media comprising computer-readable instructions for carrying out the described processes are provided.

### BRIEF DESCRIPTION OF THE DRAWINGS

The present application can be best understood by reference to the following description taken in conjunction with the accompanying drawing figures and screen shots included herein, in which like elements may be referred to by like numerals.

FIG. 1 illustrates an exemplary system architecture and environment for supporting systems and processes described herein.

FIG. 2 illustrates an exemplary system architecture for supporting systems and processes described herein.

FIGS. 3A and 3B illustrate binomial trees for use in a rule discovery process.

FIG. 4A illustrates an exemplary process for providing alerts to users about potentially significant associations between an AE and a patient attribute.

FIG. 4B illustrates a schematic illustration of detecting a significant association between an AE and a patient attribute and providing an alert.

FIG. 5 illustrates an exemplary process for altering the display (e.g., ranking or prioritization scores) of information in response to a user's query.

FIG. 6 illustrates an exemplary screenshot of a point-of-care DSS-based ADR query.

FIG. 7 illustrates an exemplary screenshot of information extracted from the pharmaceutical drug labels associated with the drugs being taken by a patient.

FIG. 8 illustrates an exemplary screenshot of the extracted information that is assigned a ranking or prioritization score using a pre-determined algorithm.

FIG. 9 illustrates an exemplary screenshot of extracted information derived from drug labels that is ordered for display back to the doctor (user) making the ADR query.

FIGS. 10 and 11 illustrate exemplary screenshots of an unaltered and altered display of search results, the altered display based on an exemplary process described herein.

### DETAILED DESCRIPTION

The following description sets forth numerous specific configurations, parameters, and the like. It should be recognized, however, that such description is not intended as a limitation on the scope of the present invention, but is instead provided as a description of exemplary embodiments.

Broadly speaking, and in one example, systems and processes are described for processing database information of AEs (including ADRs), and patient attributes, and identifying association rules between one or more AEs and one or more patient attributes. For instance, one or more algorithms may be used to evaluate a database of AEs and patient attributes to discover associations (e.g., rules) that satisfy predefined thresholds (e.g., for support, confidence, interestingness, etc.). Such rules may be used within a medical point-of-care clinical reference system or decision support system (DSS) for processing of AEs and patient attributes.

In one example, exemplary processes include notifying or alerting users of a computer-based, clinical decision support system, of potentially significant associations (causal or not) between AEs and patient attributes. For example, the computer-based, clinical decision support system generally processes AEs (e.g., pre- and post-marketing adverse drug events, reported AEs, and so on) to determine associations and provide alerts to users. In one example, the associations are applied to patient data (e.g., patient data associated with a hospital or organization) to provide patient-specific alerts or notifications specific to one or more patients. In another example, systems and processes for prioritizing results retrieved from pharmaceutical drug labels in response to a user's query are provided.

I. System Architecture and Environment.

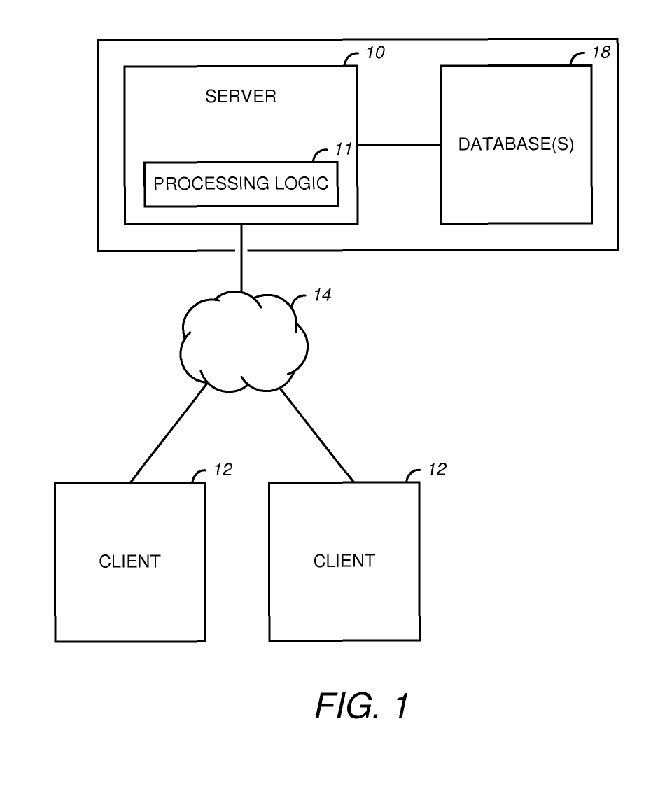

Initially, and with reference to FIG. 1, an exemplary environment in which certain aspects and examples of the user interfaces, apparatuses, and processes described are provided. Generally, one or more clients 12 may access a server 10, which includes or accesses logic for performing one or more exemplary processes described, e.g., providing an interface for a user to input queries, review results, receive information and alerts and so on. Server 10 and clients 12 may include any one of various types of computer devices, having, e.g., a processing unit, a memory (which may include logic or software for carrying out some or all of the functions described herein), and a communication interface, as well as other conventional computer components (e.g., input device(s), such as a keyboard/keypad and/or mouse, output device, such as display). For example, clients 12 may include a desktop computer, laptop computer, mobile device such as a handheld computing device, mobile phone, web-enabled phone, smart phone, and the like.

Clients 12 and server 10 may communicate, e.g., using suitable communication interfaces via a network 14, such as a Local Area Network (LAN) or the Internet. Clients 12 and server 10 may communicate, in part or in whole, via wireless or hardwired communications, such as Ethernet, IEEE 802.11b wireless, or the like. Additionally, communication between clients 12 and server 10 may include or communicate with various servers such as a mail server, mobile server, media server, and the like.

Server 10 generally includes logic (e.g., http web server logic) or is programmed to format data, accessed from local or remote databases or other sources of data and content, for presentation to users of clients 12, preferably in the format described herein. For example, server 10 may format data and/or access a local or remote database to communicate and cause the display of an interface to clients 12, data related to objects for display within an interface (which may include a search interface and display window for displaying objects, for example), links to additional information and/or content related to the objects, the additional content and/or information itself, and the like. To this end, server 10 may utilize various web data interface techniques such as Common Gateway Interface (CGI) protocol and associated applications (or “scripts”, Java® “servlets”, i.e., Java® applications running on a web server), or the like to present information and receive input from clients 12. The server 10, although described herein in the singular, may actually comprise plural computers, devices, databases, associated backend devices, and the like, communicating (wired and/or wireless) and cooperating to perform some or all of the functions described herein. Server 10 may further include or communicate with account servers (e.g., email servers), mobile servers, media servers, and the like.

Further, web pages communicated to clients 12 may include various text and media objects such as articles, documents, photos, audio files, video files, and the like. Additionally, the content may include selections or links to further content accessible by the interface and associated user device, e.g., via Application Programming Interfaces (APIs), web pages, and the like stored or accessed locally or remotely. Content accessible by clients 12 via a presented web page may conform to any suitable data format including various media formats such as still image (e.g., JPEG, TIFF), video (e.g., MPEG, AVI, Flash), or audio (e.g., MP3, OGG).

In one example, server 10 includes or communicates with processing logic 11 for processing data (e.g., AEs and patient attributes) and discovering associations, such as association rules, as described below. Processing logic 11 may further include logic for causing the display of an interface for receiving search queries and associated information, and displaying results based on user input. For example, server 10 may include one or more application servers configured to implement and execute software applications as well as provide related data, code, forms, web pages, and other information to and from clients 12 and to store to, and retrieve from, a database system related data, objects and web page content.

It should be noted that although the exemplary methods and systems described herein describe use of a separate server and database systems for performing various functions, other embodiments could be implemented by storing the software or programming that operates to cause the described functions on a single device or any combination of multiple devices as a matter of design choice so long as the functionality described is performed. Although not depicted in the figures, server 10 and database system 18 generally include such art recognized components as are ordinarily found in server systems, including, but not limited to, processors, RAM, ROM, clocks, hardware drivers, associated storage, and the like. Further, the described functions and logic may be included in software, hardware, firmware, or combination thereof.

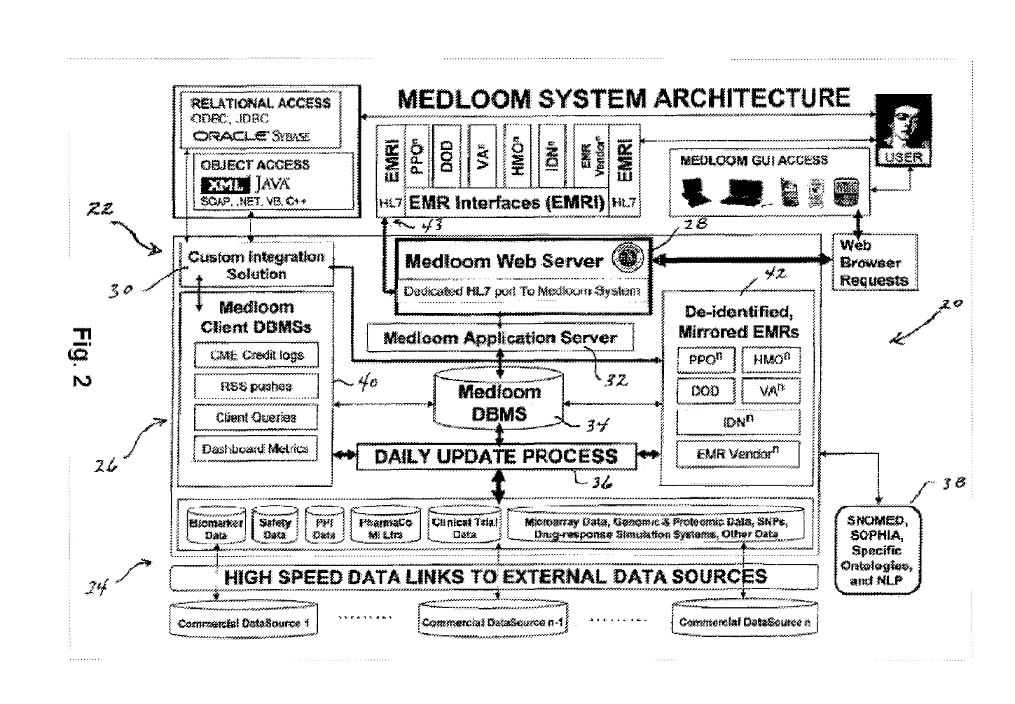

FIG. 2 illustrates a more detailed exemplary medical assessment support system 20 for carrying out various processes described herein. Similar exemplary medical assessment and DSSs are described in co-pending PCT patent application No. PCT/US2008/054778, filed Feb. 22, 2008, titled Automated Ontology Generation System and Method,” and U.S. patent application Ser. No. 12/438,530, filed Feb. 23, 2009, entitled, “Medical Assessment Support System and Method,” both of which are incorporated herein in their entirety.

Exemplary system 20 may include: (a) a user interface 22 that facilitates communications between system 20 and an electronic or computing device associated with a user, (b) a data interface 24 that facilitates communications between system 20 and one or more sources of data or information that are used to service a query that a user communicates to system 20 over the user interface 22, and (c) a processing engine 26 that causes one or more searches of data or information sources to be conducted in response to a user query submitted over the user interface 22 and provides the results of the search or searches to the user over user interface 22.

User interface 22 may comprise a server 28, e.g., a web server that is capable of communicating with a client Web browser-enabled electronic or computing device that is associated with a user. The electronic or computing devices that server 28 is capable of communicating with include, but are not limited to, personal computers, PDAs, and cell phones that are capable of running a Web browser. Server 28 provides the client browser with a display of a form that contains fields that are linked to a Data Base Management System via Caché Server Pages (CSP); in other examples, non-Cache-based links, interfaces, DBMS may be used. Server 28 and client browser maintain a one-to-one association that may include, but is not limited to, the following: (1) a drug information entry field(s); (2) a medical device entry field(s); (3) a procedure entry field(s); (4) an ailment (e.g., condition or symptom) information entry field(s); (5) a data source information entry field(s); (6) patient demographic data entry fields (age, gender, etc.); and (7) an Adverse Event information entry field(s). All fields are linked to information stored internally in the data base management system (DBMS). It should be appreciated that server 28 can be replaced or supplemented with another type of server should communications with one or more users need to be conducted over a network (wide-area or local-area) other than the Web. Server 28 may also be capable of communicating with an electronic or computing device that is associated with a user and capable of HL7 messaging, a messaging standard that is widely used in the healthcare industry. Server 28 may be adapted to support other messaging protocols that are present in the healthcare industry or are adopted by the healthcare industry in the future. Server 28 is illustrated as a single server with a web browser port and an HL7 port; however, it should be appreciated that server 28 can comprise multiple servers, each with one or more ports.

User interface 22 may also comprise a custom integration solution interface 30 that allows a user to bypass server 28 and directly access the database management system or systems associated with the processing engine 26. The custom integration solution interface 30 may accept queries that are in accordance with relational database or object-oriented database protocols. For example, the interface 30 may be capable of receiving relational database queries that utilize ODBC or JDBC protocols for SQL-type queries and transmitting responses in an SQL format. The interface is also capable of receiving queries based on JAVA, C++, VB, SOAP, .NET, etc. and transmitting responses in the appropriate format. Interface 30 can further be adapted to integrate with other protocols if desired. The ability to process relational or object-oriented database queries can be realized by basing the processing engine 26 on CACHE, which is protocol-intelligent, i.e., capable of recognizing the protocol upon which a query is based. It should be appreciated that any other system that is protocol-intelligent could also be employed.

In this example, system 20 provides for communication with a user by a browser port and an HL7 port that are each associated with server 26 and the custom integration solution interface 30. It should be appreciated that system 20 can be adapted to employ a subset of these various interfaces for communicating with an electronic or computing device associated with a user. Further, system 20 can be adapted to employ other interfaces for communicating with an electronic or computing device associated with a user that are now available or may in the future become available.

With continuing reference to FIG. 2, data interface 24 is used to transmit requests for data or information to data sources, which are typically commercial data sources but may also include private, proprietary, or public data sources, and receive data or information from these sources that is utilized to build one or more databases that are part of the processing engine 26. In this example, data interface 24 is used to transmit requests to data sources that provide biomarker data, safety data, pharmaceutical package insert (PPI) data, pharmaceutical company medical information (MI) letters, white papers (not shown), clinical trial data, microarray data, genomic and/or proteomic data, single nucleotide polymorphisms (SNPs), drug-response simulation systems, etc., and receive the responses to any such requests. Data interface 24 is capable of transmitting requests and receives responses to one or more data sources that provide a subset of the noted types of data or information. Data interface 24 is also capable of being adapted to transmit requests and receive responses to one or more data sources that provide different types of data from the noted types of data or information. In the illustrated example, data interface 24 is a back-end communication interface that supports various major communication protocols including HL7, XML, JDBC, ODBC and others. Data interface 24 may have the ability to communicate with disparate external systems and uses internal class structure to parse and merge data into the DBMS quickly and efficiently. The DBMS stores the data in a variety of different ways (object, relational tables, and/or other) and can quickly respond to relational or object queries.

With continuing reference to FIG. 2, processing engine 26 may include: (a) an application server 32 that processes each query presented by a user via the server 28; (b) a DBMS 34, (c) an update processor 36 that updates one or more databases maintained by system 20 at specified times, e.g., daily, (d) an ontology and/or natural language processor 38, (e) a client database management system 40 that is capable of causing a search or searches for adverse events based upon a user-specified combination of drug(s), foods and other substances, medical device(s), procedure(s), patient demographics, and ailment(s), a search or searches based on user-specified AE(s), and at least one of an ailment(s) and/or drug(s), providing metrics to users that quantify the benefit of the system to the user, and monitoring continuing medical education credits for users that are health care providers based on the use of system, and (f)(i) a de-identified electronic medical record database 42 that contains the electronic medical records of patients of, for example an HMO, that have been de-identified, i.e., cannot be associated with an individual by the individual's name or other identifying information, such as residential address and/or (f)(ii) an application program interface (API) that allows access to an electronic medical record database (via an electronic medical record interface 43) deidentified or otherwise, that resides outside the system 20 but that is accessible to system 20. In the illustrated example, processing engine 26 is a multi-dimensional Post Data Base Management System that stores data as objects (Objects) and tables (SQL Relational). Data can be accessed directly using object-oriented languages (.net, Java, XML etc.) and/or database languages that adhere to the SQL, the DBMS relational industry standard. DBMS 34 may utilize a transactional bit-map indexing scheme to enhance user response time.

It will be recognized that a computer-readable medium can be used to store (e.g., tangibly embody) one or more computer programs for performing any one of the described processes by means of a computer. The computer program may be written, for example, in a general-purpose programming language (e.g., Pascal, C, C++) or some specialized application-specific language.

II. Association Discovery Processes.

According to one aspect of the present invention, processes for evaluating data, including AEs and patient attributes, and identifying meaningful patterns within the data are provided. In one example, associations or association rules are discovered through application of an association rule discovery algorithm applied to one or more databases, including, for example, data derived from post-marketing drug safety surveillance, user-reported AEs, and the like. The associations to which the algorithm is applied relate specific AEs experienced by patients to the unique combinations of medications, non-medication interventions, background conditions and symptoms, and other factors of those patients (i.e., patient attributes and demographics).

One exemplary data-mining method for discovering patterns of interest within data is known as “association rule discovery” for discovering associations or patterns within data, the discovered associations typically referred to as an “association rule.” An association rule is an expression of the form X=>Y, where X and Y are itemsets. Broadly, the association rule expresses the association that if a transaction contains all items in X, then that transaction also contains all items in Y. (X is generally referred to as the body or antecedent, and Y is called the head or consequent of the rule.) Itemsets are sets of items which are subsets of the set of all possible items. For example, {fever,headache}=>{flu} states that if the itemset {fever,headache} is true, then itemset {flu} is true. The association rules are learned from a collection of transactions where each transaction itself is also an itemset; as an illustrative example, in a market basket analysis problem, each transaction contains items that a customer purchased. Typically, the data of a problem contains thousands of possible items and possibly millions of transactions. By way of demonstration, consider the simple example where the set of possible items is I={beer, chips, pizza, wine} and the transaction database contain only four transactions shown in Table 1.

TABLE 1
Transaction Database
Transaction

{beer, chips, wine}
{beer, chips}
{pizza, wine}
{chips, pizza}

Association rule discovery identifies frequent item sets and generates rules from them. Frequent itemsets are those itemsets that have a support greater than a given support threshold. The support is the frequency of how often the itemset occurs as a subset of a transaction across transactions (referred to as its support) normalized by dividing by the size of transaction database. For example, {beer, chips} occurs 2 times, such that its support is 2/4=0.5. Association rules of interest are those exceeding a confidence threshold. The confidence of rule X=>Y is measured by the support(X U Y)/support(X). This can be viewed as the probability that Y holds given X holds. For example, for rule: {beer,chips}=>{wine}, the confidence=support ({beer,chips,wine})/support({beer,chips})=0.25/0.5=0.5. Thus, the probability that if someone buys beer and chips they also buy wine is 0.5, or 50%.

Accordingly, the association rules generally describe and identify frequent co-occurrences in sets of data; for example, which items frequently occur together. This can be viewed as the probability that if, for example, a Patient-type A takes Drugs B and C and has a background of heart disease E, they develop ADR type F (whether the relationship is causal or not; in other words, the process identifies potential correlations and not necessarily causal associations).

To select interesting or meaningful rules from the set of all possible rules, constraints on various measures of significance and interest can be used. For example, constraints may include minimum thresholds on support and confidence, where support of a rule is defined as the proportion of transactions in the data set which contain the itemset, and confidence of a rule is defined as the percentage of transactions for which the rule is correct, e.g., an estimate of the probability that the rule is correct. In some examples, the system administrator and/or end user may have control over the thresholds of support, confidence, and/or interestingness and may adjust the thresholds up or down as desired.

It should be noted that various algorithms for generating association rules are contemplated, and include, but are not limited to, Apriori, Eclat, and Frequent Pattern growth (FP-growth), one-attribute-rule (OneR) algorithms. Additionally, other types of association mining are contemplated, including, e.g., contrast set learning, K-optimal pattern discovery, and mining frequent sequences.

Accordingly, in one example, exemplary algorithms for discovering associations (such as the association rule discovery algorithms described) can be applied to database information, e.g., AERS databases, commercial or proprietary databases, and so on. The discovered associations may be checked or validated against predetermined thresholds for support, confidence, and/or interestingness, and used by a medical reference or clinical decision support system in a variety of ways. In one example, the processes may identify new associations between drugs and AEs, and alert doctors and patients in a timely manner of potential risks.

In one illustrative example, an association rule discovery process includes two phases: 1) finding all frequent subsets of Drugs, Effects (D, X), satisfying the given support threshold, where D ⊂ I is a subset of drugs and X ∈ I is an effect; and 2) selecting the association rule among the association rules which are derived from the found frequent sets for which p(X\D) (confidence) is high enough.

An Apriori method may be used for identifying frequent item sets, which generally includes scanning a database of itemsets, each including a number of items, and identifying frequent items. The method can generate candidates for frequent itemsets by taking the frequent items together in all possible pairs. The database can then be scanned to determine the frequency of each candidate pair. Once frequent pairs have been identified, candidates for frequent itemsets, each with three items, can be generated by taking each frequent pair together with another one. On every step the method can generate candidate item sets of length k from item sets of length k−1. The method can proceed iteratively to identify frequent patterns of any length.

In another illustrative example, a modification of the above process may be used. Initially it is noted that while using low values of support there is an exponential rise in an algorithm's execution time. To avoid this rise in execution time, an exemplary process may alternate the first step of the above algorithm with the second one for relatively small transaction sets. The rules search can be generated independently for different effects, Xⱼ, j= 1̅,̅m̅, which may help reduce the number of transactions that are analyzed simultaneously. For example, for each effect, Xⱼ, one finds:
1. Set of transactions T(Xⱼ) that contain this effect; and
2. Probability distribution pₓ_{ⱼ} of drugs from these transactions:
   Consider drug frequency df(Dᵢ,T(X))−the number of Dᵢ drugs in the set of transactions T(X). For every drug Dᵢ ∈ T(Xⱼ) we can calculate its probability:

$$p ( {D}_{i} ) = \frac{df ( {D}_{i} , T ( {X}_{j} )}{{\sum }_{{D}_{i}} df ( {D}_{i} , T ( {X}_{j} )} .$$

The probability distribution can the be taken as the vector

pₓ_{ⱼ}=p(D₁), p(D₂), . . . , p(Dₖ)).
3. The Entropy H(Xⱼ), which is a measure of uncertainty of a random variable, can be defined by the following expression:

$$H ( {X}_{j} ) = - {\sum }_{{D}_{i}} {p}_{{X}_{j}} ( {D}_{i} ) log {p}_{{X}_{j}} ( {D}_{i} ) .$$

When the probability is uniformly distributed, there is the most uncertainty about the outcome, i.e., the entropy is the highest. On the other hand, when the data have a highly skewed probability distribution function, then the variable is likely to fall within a small set of outcomes, so the uncertainty and the entropy are low. Accordingly, in one example, the process arranges or ranks all effects in order of entropy increase: X₁, X₂, . . . , Xₘ. Rules found for each of the effects (e.g., starting from the effect X₁ with the minimum entropy, then to the second effect, and so on), can be combined into one final set of rules. Note that it is not necessary to generate all possible association rules between items in the database. For example, assume that association rules have been found for the set of effects X₁, X₂, . . . , Xₖ. If the process or system runs out of computational capabilities (performance time, memory usage, etc.), the process may cease. Even in such a case, the most interesting and useful rules will likely be found based on the described entropy ordering.

In one example, the information about drug subsets may be stored using binomial trees. Advantages of such a representation may include transforming the database into a compact tree structure and avoiding costly database scans and candidate generations (of course, as will be understood by those of skill in the art, various other data structures may be used). In this particular example, a binomial tree of order k≧0, with root R is the tree Bₖ, may be defined as follows:
If k=0, Bₖ=B₀={R}. That is, the binomial tree of order zero consists of a single node, R.
If k>0, Bₖ={R, B₀,B₁, . . . , Bₖ₋₁}. That is, the binomial tree of order k>0 comprises the root R, and k binomial subtrees, B₀, B₁, . . . , Bₖ₋₁.

The root of Bₖ has k children where the i^{th} child is a binomial tree of order k-i. Because of its unique structure, a binomial tree of order k can be constructed from two trees of order k-1 trivially by attaching one of them as an outermost child of the other one. Binomial tree properties generally include:
The binomial tree of order k, Bₖ , contains 2^{k} nodes.
The height of Bₖ, the binomial tree of order k, is k.
The number of nodes at level i in Bₖ, the binomial tree of order k, where 0≦i≦k, is given by the binomial coefficient

$$( \begin{matrix}k \\ i\end{matrix} ) .$$

Using the definition and properties of binomial trees, a set of binomial trees can be created with labeled nodes that contain information about drug frequencies within T(Xⱼ). The process may then map each transaction of the length k from T(Xⱼ) into the binomial tree Bₖ, assign drug IDs to the nodes according to their position in the transaction (where each drug is ordered in each transaction by drug ID or by drug name), and combine trees that correspond to the one effect. In this case, the process provides a compact data structure that contains information about drug frequencies and corresponding effects. In addition, each subset may correspond with the only path from the root of the tree and vice-versa, thereby providing a one-to-one relationship between drugs subsets and tree paths.

Using the anti-monotony property, that is, for each set ψ ∈ I and each subset φ ⊂ ψ, the following statement is true: support (f)=support (Ψ). In other words, and in one example, the support level of an itemset cannot exceed the minimum support level of any of its subsets such that adding any item into the itemset can lead only to the decrease in the frequency of it appearing. Any subset of frequent items must be frequent as well, and no frequent itemset can include any items which are not frequent themselves in the database. This allows the exemplary process to prune tree branches in which indexes of nodes are smaller than a predefined minimum support level.

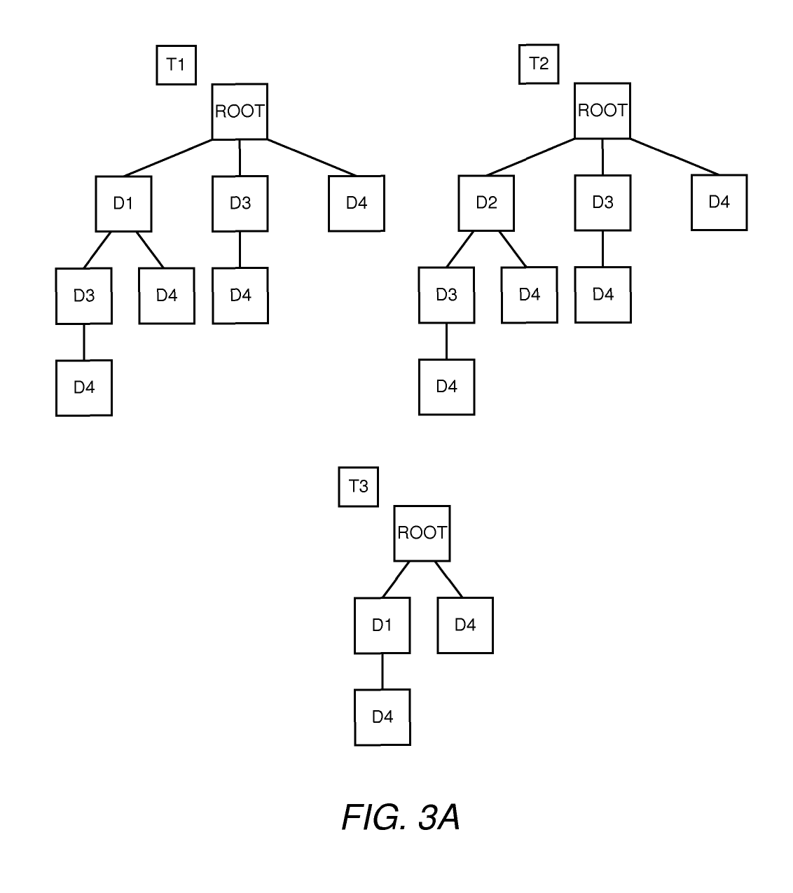

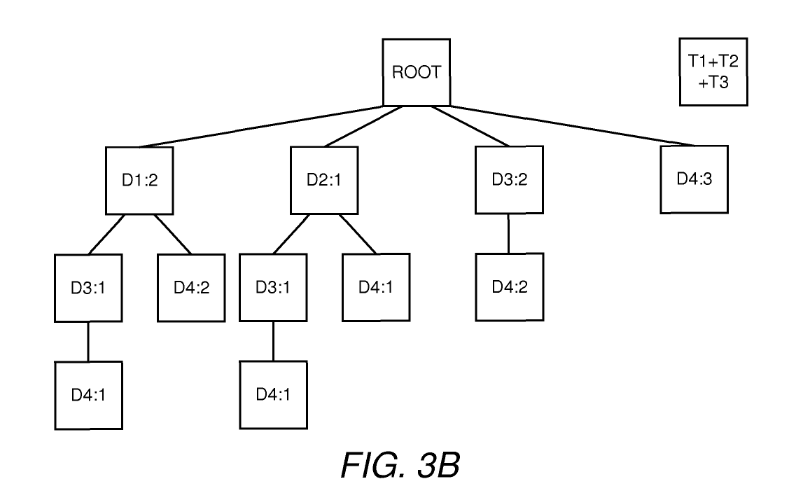

Accordingly, in this example, the association rules discovery process for a fixed effect Xⱼ can be determined according to the following algorithm or process:
1. Create a set of labeled binomial trees that contains information about all drug sets included in T(Xⱼ).
   1.1. Sort all drugs from T(Xⱼ) in increment order of IDs (or any other order of drugs);
   1.2. Map all transactions into the set of labeled binomial trees. For example, map a transaction of the length k with the tree Bₖ. For each transaction T₁ ∈ T(Xⱼ), label the tree as follows:
      root stays without labeling;
      consider nodes of the tree on the next to the Root level: assign drug IDs to the nodes according to their position in the transaction, i.e., {Dᵢ_{ⱼ}}_{j= 1̅,̅k̅}, Dᵢ ∈ Tₗ;
      assigning drug IDs to the children: for each of the Dᵢ_{ⱼ} child sites if they are not labeled yet, assign identifiers of Dᵢ_{ⱼ₊₁}, . . . , Dᵢ_{ₖ}—drugs that are to the right from the Dᵢ_{ⱼ} node in Tᵢ; and
      consecutively execute the same procedure for the children of next d level nodes, d=2, . . . , k-1, get the labeled binomial tree of order k, Bₖ.
         For example, in an example including three transactions: T₁={D₁,D₃,D₄}, T₂={D₂,D₃,D₄} and T₃={D₃,D₄}, where Dᵢ are drugs, i=1,2,3,4, binomial trees for these transactions can be represented schematically as illustrated in FIG. 3A.
   1.3. The process may further combine trees that correspond to one effect. For example, assigning an index to the nodes which are equal to the number of trees in which the corresponding path that ends in the given node exists. For the above mentioned example shown in FIG. 3A, the tree will look as shown in FIG. 3B.
      The process may then examine only such sets of drugs D, for which:
   tf (D,T(X))≧support·|T|
      where transaction frequency tf(D,T(X)) is the number of transactions in T(X) that contain the set D, and |T| is the total number of transactions in the database.
2. For each acceptable D from “1.” above, the process checks:
   tf (D,T(X))≧confidence·tf(D,T)
      for calculating tf(D,T) a DrugsTransactions table can be used.
3. Drug sets which satisfy conditions from “1.” and “2.” above, form rules D→X, which are added into the final set of “interesting” rules.

It should be recognized that the exemplary processes described herein for association rules are illustrative and modifications to the processes, as well as different processes, may be used.

### III. Providing Alerts/Information Based on Discovered Associations.

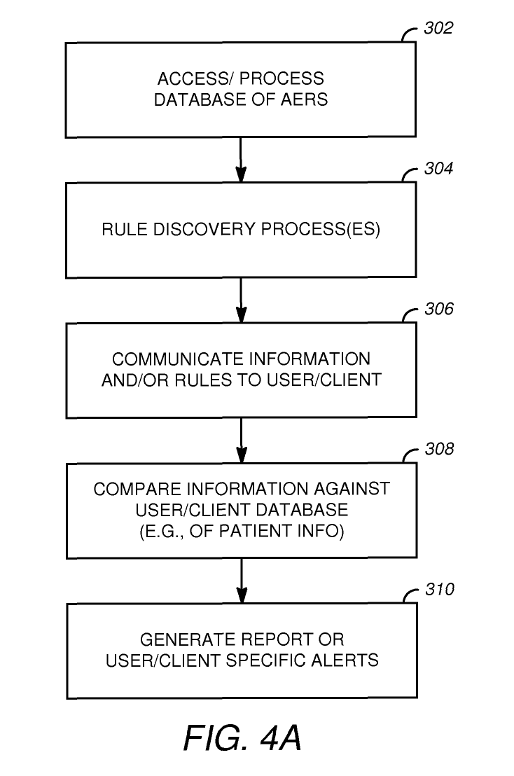

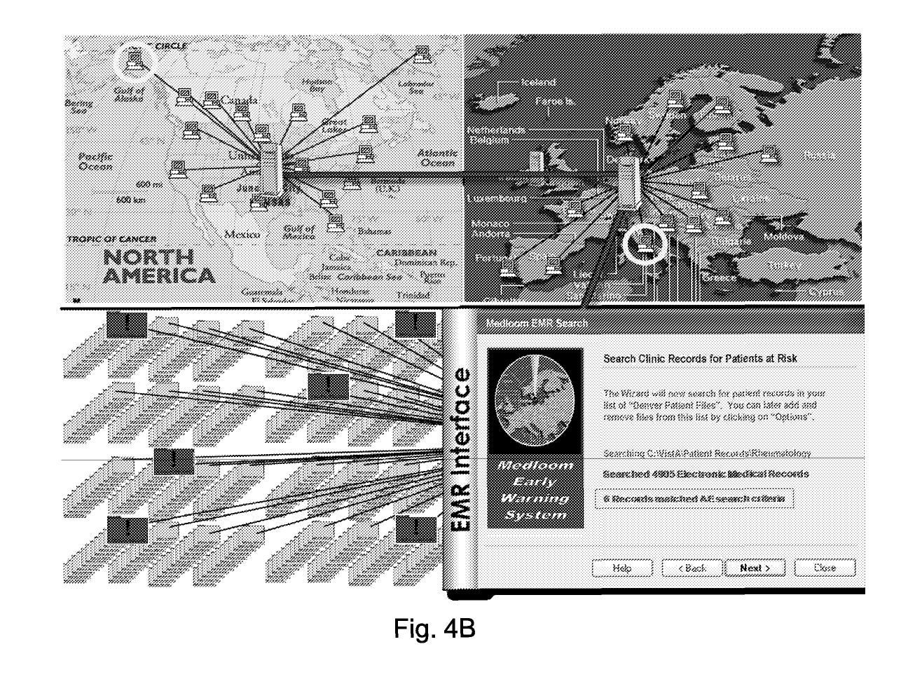

FIG. 4A illustrates an exemplary process for processing a database of information for associations and providing alerts or information to a user of a medical reference or clinical decision system. Further, FIG. 4B illustrates a schematic illustration of detecting a significant association between an AE and a patient attribute and providing an alert; for example, where AEs and patient attributes are accessed from various remote locations and can be used to scan a clinic's database of patient records for potential risks that match AE search criteria.

According to the exemplary process, a database of AEs and patient attribute data (e.g., AERS data, proprietary data, etc.) is accessed at 302. For example, the database may include one or more databases of information, including, but not limited to, safety data, biomarker data, clinical trial data, lab test data, genomic data, genetic data, commercial or proprietary data sources, and so on (see, e.g., FIG. 2). Further, the accessed database may include plural database systems and be partially or wholly remote to the processor(s) performing the process.

The data is processed at 304, for example, via an algorithm for identifying patterns or associations between clinical attributes of patients (e.g., between drug(s), medical device(s), clinical procedure(s), conditions, symptoms, demographic data, etc.) and AEs. In one example, the process includes an association rule discovery process, as described above, to identify one or more association rules, which can then be utilized by a medical reference system or DSS to provide alerts or notifications, or present safety information.

Information based on, or obtained through, the processing of 304 can be communicated to a user at 306. In one example, new or updated association rules that exceed a threshold may be communicated to a client in a number of ways, including daily, weekly, monthly, and so on. Further, the information can be communicated as an alert via an email, text message, page, phone call, webpage posting, pop-up message within an associated user interface, included within a news bulletin or publication, or the like.

In one example, the exemplary process further compares the information obtained from the rule discovery process against a user's database at 308, and generates a report or specific alert for particular patients at 410. For example, a new or updated association rule can be compared against a clinic's patient database to assist in ongoing or future medical decisions (e.g., to alert the clinic of patients at potential risk). In one example, the system may send an alert to a user regarding a new potential AE associated with a patient and known drugs prescribed. Such comparisons may be made periodically, e.g., weekly with known or newly discovered associations. In some examples, when a new association is discovered, and satisfies thresholds, the association can be used to process patient data and alert the user of the system in a more immediate, real-time manner. The comparison process may be carried out by the server, the client, or a combination thereof.

In other examples, users may submit criteria of particular AEs and patient attributes and receive alerts based on the criteria. The alerts may be based on any new reports or as associations are known or discovered. For example, a user may ask for information or alerts of any AEs reported or associated with drug X in the context of patients having condition Y. In another example, a user may ask for information or alerts of AEs associated with drug X in the context of patients having condition Y, the association being one that lies above a specified or default threshold or thresholds (which may be adjusted by the user or administrator of the system).

IV. Displaying and Prioritizing Adverse Drug Event Search Results.

A point-of-care medical reference system or DSS can be used to enable users to search through drug labels to find ADRs that a particular prescribed drug may be associated with (causally or not). This feature enables the medical practitioner to make more informed decisions as to which drug may be contributing to an observed ADR or ADRs. The use of a pre-specified ranking or prioritization algorithm to determine the order of results retrieved from drug labels and presented to the doctor or other healthcare provider making an ADR query through a DSS presumes that the algorithm has a built-in awareness of the relevance of information retrieved from drug labels in the course of processing that ADR query. The degree to which ADR information contained in drug labels reflects the reality of the seriousness and frequency of that ADR in the post-marketing world (i.e., the safety experience of that drug outside of the relatively small and demographically defined patient population that was used in the clinical trial upon which the drug's approval was based) depends on many factors, including various means of emphasis mandated by regulatory agencies themselves, but also on the frequency that drug labels are updated to reflect changes in those factors in the post-marketing world.

Awareness of the relevance of different pieces of drug label-derived safety information, and appropriate ranking of their importance, may be improved by conducting analysis of ADR reports collected after a drug has been launched for commercial use. Such real-world ADR reports generally represent use of a drug in patients over a longer temporal period, in a larger geographic area, and from a broader assortment of patient types than are represented by the safety information contained in a drug label. This is true when a drug has just been approved based on an analysis of the benefits and risks measured in a relatively small registration clinical trial used for approval of that drug, but it is also true, although to less extent, even after a drug has been on the market for an extended period of time. In either case, clinically critical ADR information may be cryptically stated, only briefly mentioned, or mentioned as being uncommon if a drug label has not been updated recently enough to reflect real-world experiences that suggest a higher priority may need to be placed on that information. The benefits of an AI-based system that makes use of real-world, post-marketing safety surveillance-derived ADR reports and their associated factors may provide an ability to bring ‘to the surface’ that ADR information from pharmaceutical drug labels that otherwise might be presented with less importance or relevance among a list of results retrieved in response to an ADR query.

Some nations have regulatory agencies that collate reported AEs observed in the field by medical practitioners countrywide in an AERS. This can be a massive resource that could be used to add extra intelligence to a DSS drug label search feature, in that information discovered in an AERS data set could be used to weight the results of the drug label searches to ensure those adverse interactions which are being reported on in the field are more visible to the medical reference system or DSS user. When an AE or AEs associated with particular drugs are being heavily reported in the field, then this information may be of value to the doctor or other healthcare provider who has observed that AE or AEs in a patient.

In one exemplary search and display process, a user inputs a query that may identify one or more ADRs that a patient has experienced, the medications and non-medication interventions with which a patient is being treated, the background conditions and symptoms for which a patient is being treated, other patient attributes, and patient demographic information. In response, the system causes one or more searches through one or more drug label databases, data bases of drug safety or efficacy information, or the like, and pre-orders the results retrieved from the databases for presentation to the user. Also, in response, the system causes one or more searches through one or more ADR databases to be performed to identify reports of ADRs associated with similar patient characteristics, and the system applies artificial intelligence technology, e.g., association rule discovery processes, to the ADR database to discover association rules and/or derive weighting factors that may be used to alter the ranking or prioritization score that impacts how drug label-derived ADR information is delivered to users of the present system.

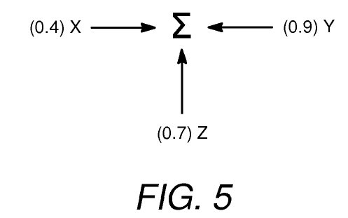

In one example, identified associations or association rules can be used as components of weighting factors that are summed to determine the magnitude of impact made on a re-ordering of the presentation of results retrieved from drug labels in response to an ADR query made using a medical reference system or DSS. FIG. 5 illustrates an exemplary process wherein upon choosing an option to apply artificial intelligence to the algorithm that determines the order of presentation of results, the user allows an association rule discovery algorithm to be run through a database of ADR reports to determine a mathematical “weight” to be assigned to a factor (X), in which the factor may reflect changes in ADR frequency or seriousness, degree of relevance to patient, similarity of drug combinations in any ADR, etc. In addition, association rule discovery can be applied to additional data sources (AERS or not) to derive additional weighting factors (Y and Z) to influence a prioritization or ranking algorithm. All, some, or no weighting factors can be added into calculating the degree to which a pre-determined ranking or prioritization score is impacted and consequently, affects the order of results derived from a drug label to be presented to the doctor or other user of the present system making the ADR query. Any weighting factors X, Y, and Z derived from the AI technology of Association Rule Discovery are applied to alter the ranking or prioritization score that impacts how drug label-derived ADR information is delivered to users of the present system such as healthcare professionals.

In another example, rules including other weighting factors that are applied to the re-ranking algorithm, and that are also derived from applying association rule discovery to a database of AEs associations, may include changes in the frequency of reports related to any specified AEs; changes in the types of ADRs, and/or AEs associated with any specified combination of medications, non-medication interventions, background conditions and symptoms; other patient attributes, or changes in any patient demographic factors associated with any specific AEs.

An initial ranking or prioritization process may include a variety of known processes. For example, the ranking or prioritization score can be assigned by a predetermined prioritization algorithm associated with a computer-based ADR query-handling medical reference system or DSS, and that score can determine the order of display of ADR-related information derived from pharmaceutical drug labels that will be presented to the user making the query. Further, exemplary search and ranking processes for use in a similar medical assessment and DSS are described in co-pending PCT patent application No. PCT/US2008/054778, filed Feb. 22, 2008, titled Automated Ontology Generation System and Method,” and U.S. patent application Ser. No. 12/438,530, filed Feb. 23, 2009, entitled, “Medical Assessment Support System and Method,” both of which are incorporated by reference herein in their entirety.

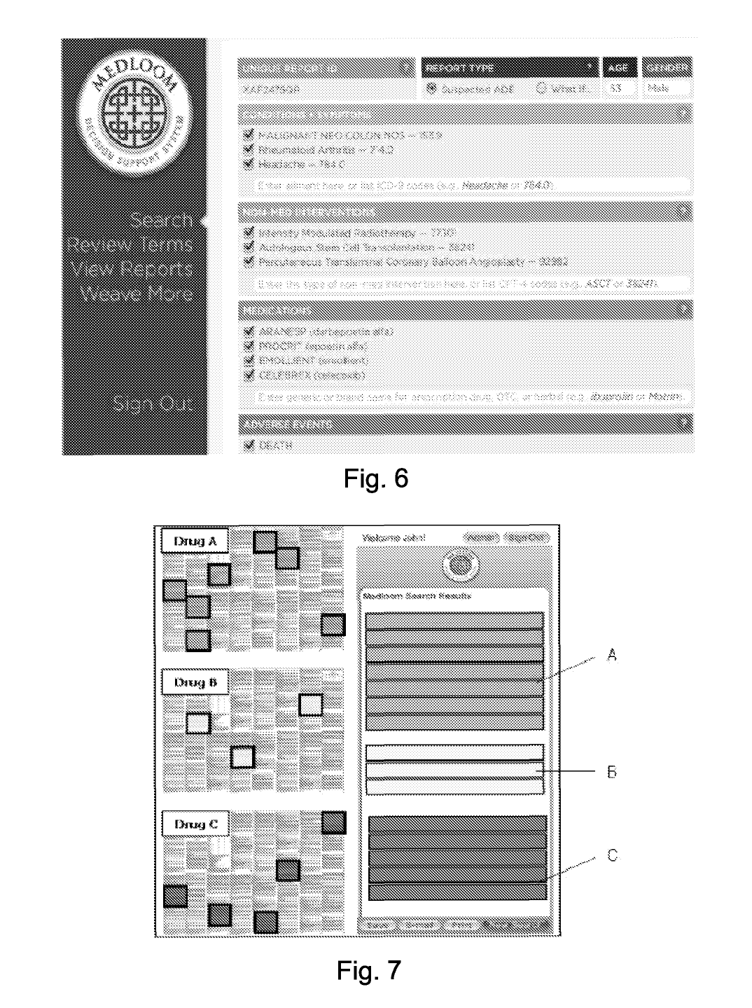

FIGS. 6-11 illustrate exemplary screenshots of a user interface showing how the exemplary association and weighting process is applied to the re-ranking of results retrieved from drug labels in response to an ADR query made by a healthcare professional. This user interface is generated by the software which carries out the present process and which is executed on a computer or computing device by a processor. The user interface itself is displayed on a computer screen coupled to the processor and interacted with via a keyboard and selector device such as a mouse. The software (set of computer instructions) is coded in any conventional computer language and stored in computer-readable memory coupled to the processor as a computer program product.

The associated database of ADR reports may be resident in memory in that same computer or may be resident on a remote computer server accessed via a computer network such as the Internet. Accessing such a database either locally or remotely is routine using conventional database access techniques such as MS SQL Server. The database may be maintained by the same organization or person that carries out the present method or by another organization such as a government organization. Moreover, coding the requisite software for the present method would be routine to one skilled in the art in light of this disclosure.

FIG. 6 illustrates an exemplary screenshot of an interface for entering search criteria in a point-of-care DSS-based ADR query. In this example, various conditions, symptoms, medications, and AEs are selected, including the AE “Death.” Additionally, the age and gender of the patient are entered with the search request. In other examples, additional, fewer, or other AEs, other patient attributes, and/or demographic data may be entered for use in the search request.

FIG. 7 illustrates an exemplary screenshot of information related to the ADR “Elevated LFT” extracted from the pharmaceutical drug labels associated with the drugs being taken by that patient in response to the search request entered in FIG. 6. Initially, the search results are retrieved from the drug labels (as illustrated on the left for drugs A, B, and C with the relevant results highlighted therein) and displayed in the interface on the right. In this example, a reproduction of the actual drug label is shown in the interface on the left, with relevant search results highlighted therein; however, such display is not necessary.

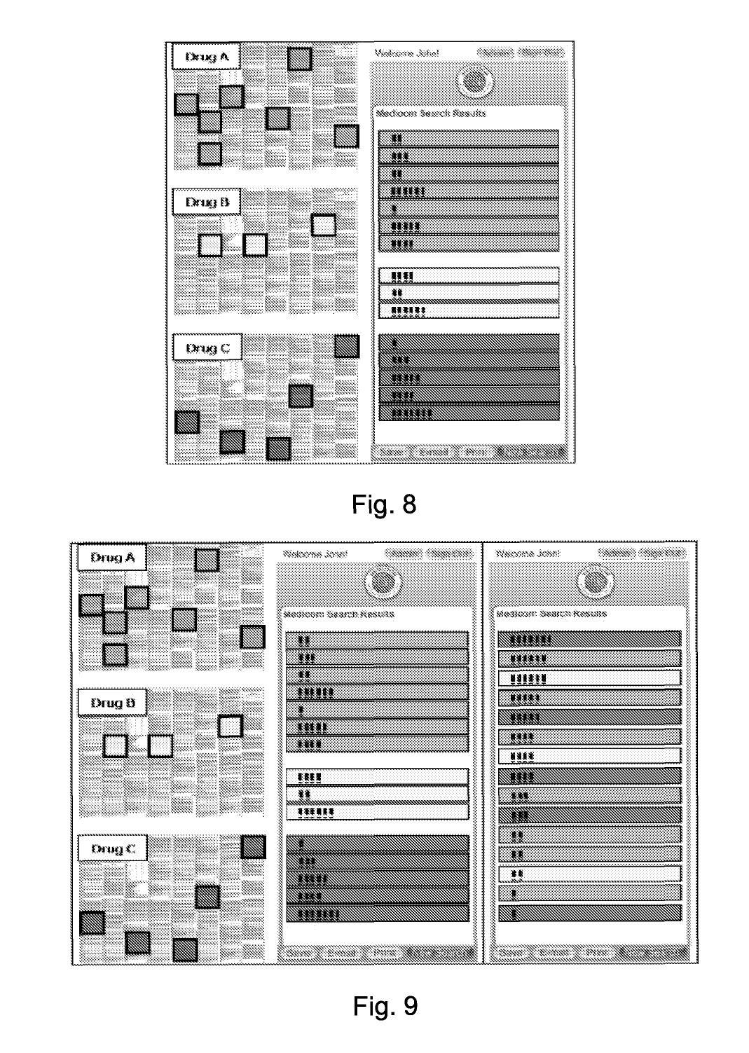

FIG. 8 illustrates an exemplary screenshot of the extracted information that has been assigned a ranking or prioritization score using a pre-determined algorithm. For example, an initial algorithm for ranking or prioritization may include or be based upon the density of concepts related to the ADR term specified in the query in each of the extracted drug label segments, the presence or absence of imperative guidance (e.g., “should” or “must” statements), regulatory agency-mandated means of emphasis (e.g., a black box warning must be surrounded by an actual black box), and/or other factors. The prioritization or ranking is illustrated by the number of “!” marks, in which more “!” marks illustrates greater importance. In this example, the results are still grouped by drug type.

FIG. 9 illustrates an exemplary screenshot of the extracted information derived from the drug labels ordered for display back to the user, e.g., healthcare professional, making the ADR query. As illustrated, the results are now displayed in a top-down order based on the prioritization or ranking assigned to each search result, and not grouped by drug type. In some examples, a visual indicator such as color may be used to identify the drug type of each result. In some examples, only the information exemplified in the right pane is displayed to a user; in other examples, information exemplified in both the center and right pane are displayed; in yet other examples, all information exemplified in the three panes are displayed.

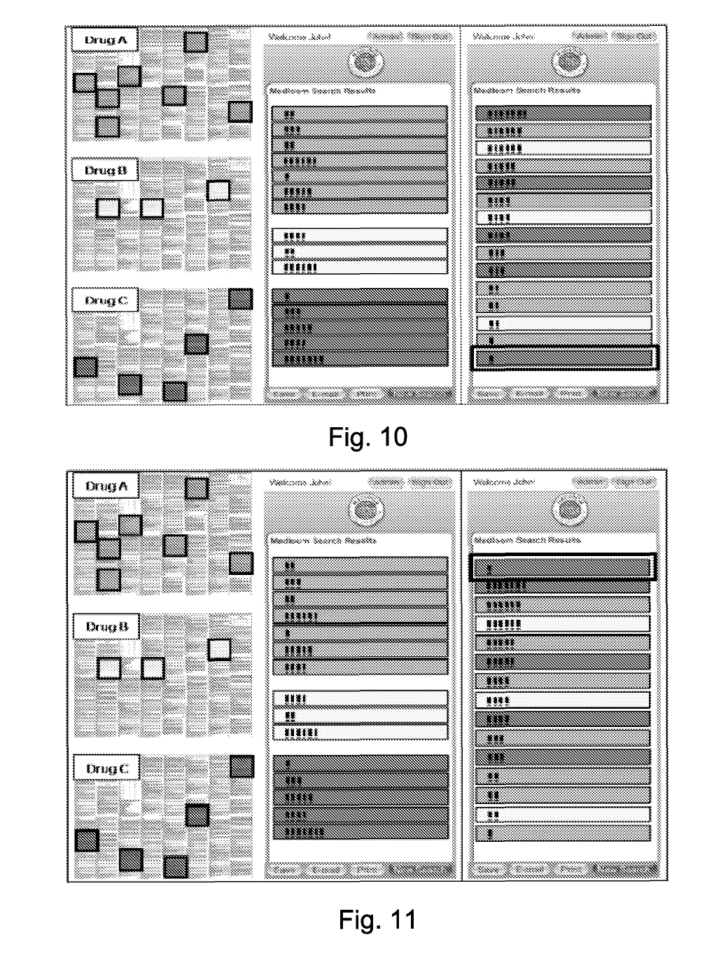

FIGS. 10 and 11 illustrate exemplary screenshots of an unaltered and altered display of search results, the altered display based on an exemplary process described herein. FIG. 10 illustrates the display of search results processed by ranking or prioritization algorithm weighting factors, derived by AI from an AERS(s) or not, or other data sources as described above. In this particular example, search results ranked with the lowest prioritization (i.e., “importance”) score, and consequently presented at the bottom of the results delivered to the user making the ADR query, are now identified as being of higher relevance and given a new ranking or prioritization score. In this case, that piece of information that had been presented at the bottom of the returned results was determined to be much more relevant to the query made because of its associations with what was being experienced in the post-marketing environment, i.e., the “real world.” As a result, it could be moved to and displayed at the top of the results presented to the user. Of course, in other examples, various search results may be moved up or down to re-rank or reprioritize the display of search results.

Accordingly, as seen in FIG. 11, the first information seen by the healthcare professional is now based on factors, potentially including the seriousness of the ADR in the after-market experience, the frequency of the ADR seen in the “real world,” reports from an AERS database(s), an increased strength of association with the patient's attributes and personal demographics compared to what was stated in the drug label, and other factors, as determined using the AI method of Association Rule Discovery. In other examples, more or fewer search results may be reprioritized and displayed to a user. For example, some users may request only one or two of the most relevant results, whereas other users may want to display or access all available search results.

Although only certain exemplary embodiments have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. A computer-implemented method for providing information regarding associations between patient attributes and one or more Adverse Events (AEs), the method comprising the acts of:
processing, via a computer processor, database information comprising AEs and one or more patient attributes for associations between AEs and patient attributes;
identifying at least one association between one or more AEs and one or more patient attributes, wherein the at least one association satisfies a threshold; and
providing information based on the at least one association to a user.

2. The method of claim 1, wherein at least one of the AEs comprises an Adverse Drug Reaction (ADR).

3. The method of claim 1, wherein at least one of the AEs and patient attributes comprises user-generated reports comprising AEs and patient attributes.

4. The method of claim 1, wherein at least one of the AEs and patient attributes comprises reported additional safety events associated with prescription drugs.

5. The method of claim 1, wherein the at least one association comprises an association rule identified by an association rule discovery algorithm.

6. The method of claim 5, wherein the threshold comprises a confidence threshold.

7. The method of claim 5, wherein the threshold comprises a support threshold.

8. The method of claim 5, wherein a plurality of association rules are identified and ordered according to an entropy value associated with each association rule.

9. The method of claim 8, where a set of the plurality of association rules are combined into a final set of association rules.

10. The method of claim 1, wherein patient attributes comprise one or more of drugs, medical devices, medical or clinical procedures, conditions, symptoms and demographic data.

11. The method of claim 1, further comprising causing a communication of an alert to the user based on the identified association.

12. The method of claim 11, wherein the alert comprises one or more of an email, text message, or post on a webpage.

13. The method of claim 1, further comprising comparing the identified at least one association to a database of patient information associated with the user, and the information is provided to the user based on the comparison.

14. A system for providing information regarding associations between patient attributes and one or more Adverse Events (AEs), the system comprising:
a server comprising a processor operable to:
process AEs and one or more patient attributes for associations between AEs and patient attributes;
identify at least one association between one or more AEs and one or more patient attributes, wherein the at least one association satisfies a threshold; and
causing a communication of information based on the at least one association to a client.

15. The system of claim 14, wherein the at least one association comprises an association rule identified by an association rule discovery algorithm.

16. The system of claim 14, wherein patient attributes comprise one or more of prescription drugs, over-the-counter drugs, herbal supplements, vitamins, foods, medical devices, medical or clinical procedures, conditions, symptoms, and demographic data.

17. The system of claim 14, further comprising causing a communication of an alert to the user based on the identified association.

18. The system of claim 14, further comprising comparing the identified at least one association to a database of patient information associated with the user, and the information is provided to the user based on the comparison.

19. A computer-readable storage medium comprising computer readable instructions for providing information regarding associations between patient attributes and one or more Adverse Events (AEs), the instructions for:
processing AEs and one or more patient attributes for associations between AEs and patient attributes;
identifying at least one association between one or more AEs and one or more patient attributes, wherein the at least one association satisfies a threshold; and
causing a communication of information based on the at least one association to a client.

20. The computer-readable storage medium of claim 19, wherein the at least one association comprises an association rule identified by an association rule discovery algorithm.

21. The computer readable storage medium of claim 19, wherein patient attributes comprise one or more of prescription drugs, over-the-counter drugs, herbal supplements, vitamins, foods, medical devices, medical or clinical procedures, conditions, or symptoms, and demographic data.

22. The computer-readable storage medium of claim 19, further comprising causing a communication of an alert to the user based on the identified association.

23. The computer-readable storage medium of claim 19, further comprising comparing the identified at least one association to a database of patient information associated with the user, and the information is provided to the user based on the comparison.

24. A computer implemented method of analyzing adverse drug events, comprising the acts of:
accessing, via a computer processor, a computer readable storage memory storing records of drug safety or efficacy information;
ordering at least a portion of the records based on at least one patient attribute;
applying one or more association rules to the records, the association rules identified from a database of Adverse Events (AEs) and patient attributes;
reordering the records based on the one or more association rules; and
displaying at least one of the records.

25. The method of claim 24, wherein the records of drug safety or efficacy information comprise drug label segments.

26. The method of claim 25, wherein the ordering of the drug label segments is based on the density of concepts related to the Adverse Event search term input in the AE query that are found in the drug label segments.

27. The method of claim 24, wherein the act of accessing includes accessing a remote server via a computer network.

28. The method of claim 24, further comprising the act of assigning a weight to an association rule.

29. The method of claim 28, wherein the weight influences the effect of the association rule on the reordering of the records.

30. The method of claim 28, wherein the weight represents one of seriousness of the type of adverse drug events, degree of relevance to a patient, similarity of drug combinations associated with an adverse drug event, recent change in the frequency of adverse drug event reports associated with that drug, or other characteristics of an adverse drug event.

31. A system for analyzing adverse drug events, the system comprising:
a processor operable to:
access a computer readable storage memory storing records of drug safety or efficacy information;
order at least a portion of the records based on at least one patient attribute;
apply one or more association rules to the records, the association rules identified from a database of Adverse Events (AEs) and patient attributes;
reorder the records based on the one or more association rules; and
cause the display of at least one of the records.

32. A computer-readable storage medium comprising computer-readable instructions for
accessing a computer readable storage memory storing records of drug safety or efficacy information;
ordering at least a portion of the records based on at least one patient attribute;
applying one or more association rules to the records, the association rules identified from a database of Adverse Events (AEs) and patient attributes;
reordering the records based on the one or more association rules; and
causing display of at least one of the records.
